(19) United States
(12) Patent Application Publication
(10) Pub. No.: US 2011/0309894 A1
(43) Pub. Date: Dec. 22, 2011

(54) PLANAR ASYMMETRIC CROSSOVER COUPLER

(75) Inventors: Jen-Tsai Kuo, Hsinchu City (TW); Yi-Chyun Chiou, Hsinchu City (TW); Chi-Hung Chan, Hsinchu City (TW)

(73) Assignee: NATIONAL CHIAO TUNG UNIVERSITY, Hsinchu City (TW)

(21) Appl. No.: 13/157,273

(22) Filed: Jun. 9, 2011

(30) Foreign Application Priority Data
Jun. 17, 2010 (TW) 99119677

(51) Int. Cl. H01P 5/22

(52) U.S. Cl. 333/117

(57) ABSTRACT

A planar asymmetric crossover coupler has a first branch to a seventh branch. The first branch to the fourth branch form a first region having a first port and a fourth port. The fourth branch to the seventh branch form a second region having a second port and a third port. The characteristic impedance of each branch is determined according to the load impedance and power distribution ratio of each port.

### CROSS-REFERENCE TO RELATED APPLICATION

This application claims the priority benefit of Taiwan application serial no. 99119677, filed Jun. 17, 2010. The entirety of the above-mentioned patent application is hereby incorporated by reference herein and made a part of this specification.

### BACKGROUND OF THE INVENTION

1. Field of the Invention

The present invention relates to a coupler, and more particularly, to a planar asymmetric crossover coupler.

2. Description of Related Art

Following the rapid development and the trend of higher functional requirements of microwave circuits, several functions are often integrated into one circuit, thus resulting in an increasing demand for high-density printed circuit boards. A large part of these printed circuit boards fail to meet the trend of future electronic products toward being light, thin, short, small and multi-functional. The reason is that the printed circuit boards for a large part of the electronic products need many microwave circuits, such as, power dividers, couplers, filters, stub tuners or the like.

Branch couplers are a very important component in microwave circuits and radio frequency integrated circuits, which can be used as power dividers and power combiners. U.S. Pat. No. 5,600,285 discloses a crossover coupler with a three-dimensional structure. Since this crossover coupler is of a three-dimensional structure, it is not suitable for use in planar circuits and fabrication cost thereof can be rather high. In addition, U.S. Pat. No. 5,274,839 discloses a symmetrical crossover coupler. While this symmetrical crossover coupler is applicable in the planar circuits, the symmetry of the crossover coupler significantly decreases the flexibility in designing the circuit thus making it difficult to design a crossover junction with different diagonal impedance.

### SUMMARY OF THE INVENTION

Accordingly, the present invention is directed to an asymmetric crossover coupler which has a simple structure and is easy to design, thus making it suitable for use in planar circuits and reducing fabrication cost thereof.

The present invention provides a planar asymmetric crossover coupler having a first branch to a seventh branch. The first branch to the fourth branch form a first region having a first port and a fourth port. The fourth branch to the seventh branch form a second region having a second port and a third port. The characteristic impedance of each branch is determined according to the load impedance and power distribution ratio of each port.

According to one embodiment of the present invention, the length of each branch is one quarter wavelength at the center frequency of the planar asymmetric crossover coupler.

According to one embodiment of the present invention, the first port is positioned at the junction of the first branch and the second branch, the second port is positioned at the junction of the fifth branch and the sixth branch, the third port is positioned at the junction of the fifth branch and the seventh branch, and the fourth port is positioned at the junction of the second branch and the third branch.

According to one embodiment of the present invention, the load impedance of the first port is equal to the load impedance of the third port, and the load impedance of the second port is equal to the load impedance of the fourth port, wherein the load impedance of the first port can be different from the load impedance of the second port.

According to one embodiment of the present invention, if the first port is an input port, then the second and fourth ports are isolating ports, and the third port is output port, and if the fourth port is an input port, then the first and the third ports are isolating ports, and the second port is output port.

In view of the foregoing, the embodiments of present invention can adjust the load impedance and output power of the planar asymmetric crossover coupler to meet the requirements of microwave circuits by adjusting the characteristic impedance of respective branches of the planar asymmetric crossover coupler. As such, the crossover coupler can have high design flexibility.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 illustrates a planar asymmetric crossover coupler according to one embodiment of the present invention.

FIG. 2 illustrates series-connected asymmetric branch couplers according to one embodiment of the present invention.

FIG. 3A and FIG. 3B are curve charts illustrating the relationship between the characteristic impedances of the branch coupler of FIG. 2.

FIG. 4A is a chart illustrating the frequency response of the planar asymmetric crossover coupler according to one embodiment of the present invention.

FIG. 4B is a chart illustrating the frequency response of the planar asymmetric crossover coupler according to another embodiment of the present invention.

### DESCRIPTION OF THE EMBODIMENTS

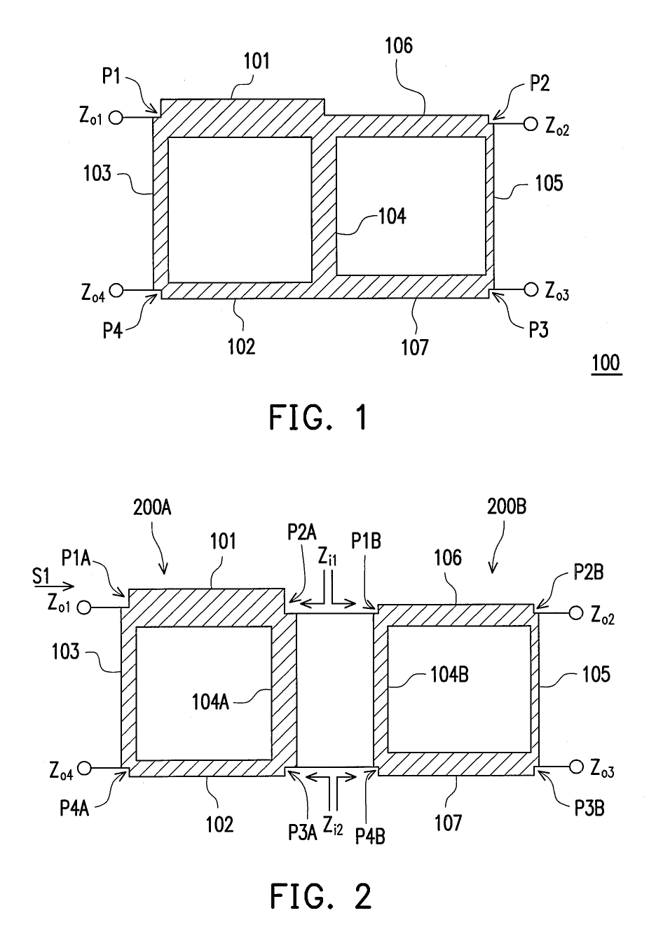

FIG. 1 illustrates a planar asymmetric crossover coupler according to one embodiment of the present invention. Referring to FIG. 1, the planar asymmetric crossover coupler 100 is a four-port element including branches 101-107. The branches 101-107 have characteristic impedances Z₁-Z₇, respectively. The branches 101, 102, 103, and 104 form a first region, and the branches 104, 105, 106, and 107 form a second region. In the present embodiment, the first region and the second region are rectangular regions. However, this is for the purposes of illustration only and should not be regarded as limiting. A first port P1 of the planar asymmetric crossover coupler 100 is positioned at the junction of the branch 101 and the branch 103, a second port P2 is positioned at the junction of the branch 105 and the branch 106, a third port P3 is positioned at the junction of the branch 105 and the branch 107, and a fourth port P4 is positioned at the junction of the branch 102 and the branch 103. The load impedances of the first to fourth ports P1-P4 are Z₀₁-Z₀₄, respectively. The length of each branch is λ/4, and λ is the wavelength at the center frequency of the planar asymmetric crossover coupler 100.

By appropriately adjusting the characteristic impedances of respective branches of the planar asymmetric crossover coupler 100, the load impedances Z₀₁-Z₀₄ of the first to fourth ports P1-P4 can be made to match respective circuits connected thereto, and the power output of the respective ports of the planar asymmetric crossover coupler 100 can be made to comply with the requirements of microwave circuits.

Adjusting the impedances of the respective branches of the planar asymmetric crossover coupler 100 can be achieved by adjusting the width of the respective branches. Below, adjustment of the impedances of the respective branches based on the load impedances and power distribution ratio of the respective ports is described by way of exemplary embodiments.

FIG. 2 illustrates a series-connected asymmetric branch coupler according to one embodiment of the present invention. Referring to FIG. 1 and FIG. 2, the planar asymmetric crossover coupler 100 of FIG. 1 can be viewed as two asymmetric branch couplers 200A and 200B of FIG. 2 that are connected in series. The asymmetric branch coupler 200A includes branches 101, 102, 103, 104A. The asymmetric branch coupler 200A includes branches 105, 106, 107, 104B. The characteristic impedances of the branch 104A and the branch 104B are Zₐ and Z_{b}, respectively. The asymmetric branch coupler 200A has first to fourth ports P1A-P4A. The asymmetric branch coupler 200B has first to fourth ports P1B-P4B.

The first port P1A of the asymmetric branch coupler 200A is positioned at the junction of the branch 101 and the branch 103, the second port P2A is positioned at the junction of the branch 101 and the branch 104A, the third port P3A is positioned at the junction of the branch 104A and the branch 102, and the fourth port P4A is positioned at the junction of the branch 102 and the branch 103. The first port P1B of the asymmetric branch coupler 200B is positioned at the branch 106 and the branch 104B, the second port P2B is positioned at the junction of the branch 105 and the branch 106, the third port P3B is positioned at the junction of the branch 105 and the branch 107, and the fourth port P4B is positioned at the junction of the branch 104B and the branch 107. The first port P1A and the fourth port P4A of the asymmetric branch coupler 200A are similar to the first port P1 and the fourth port P4 of the planar asymmetric crossover coupler 100, respectively. The second port P2B and the third port P3B of the asymmetric branch coupler 200B are similar to the second port P2 and the third port P3 of the planar asymmetric crossover coupler 100, respectively. To make the load impedances of the second port P2A and the first port P1B match with each other, the load impedances of both the second port P2A and the first port P2B are set as Zᵢ₁. Similarly, the load impedances of the third port P3A and the fourth port P4B are set as Zᵢ₂.

In the present embodiment, it is assumed that the length of each branch is λ/4, and the load impedances of the ports on the two diagonal lines of the planar asymmetric crossover coupler 100 are Z₀₁ and Z₀₂, respectively. That is, the load impedance Z₀₁ of the first port P1 is equal to the load impedance Z₀₃ of the third port P3, and the load impedance Z₀₂ of the second port P2 is equal to the load impedance Z₀₄ of the fourth port P4. In addition, the scattering coefficients S_{21A}, S_{31A} of the asymmetric branch coupler 200A are −jα_{A}, β_{A}, respectively, and the scattering coefficients S_{21B}, S_{31B} of the branch coupler are −jα_{B}, β_{B}, respectively, wherein α_{A}²+β_{A}²=1, and α_{B}²+β_{B}²=1.

Assuming that the input port of the planar asymmetric crossover coupler 100 is the first port P1, and the design specifications of the microwave circuit requires an isolation between the first port P1 and the second port P2 of the planar asymmetric crossover coupler 100, i.e. the second port P2 is an isolating port, and the power of an input signal Si is distributed to the third port P3, the scattering coefficients S₂₁, S₃₁ may then be expressed as:

S₂₁=(−jα_{A})(−jα_{B})+(−β_{A})(−β_{B})=−α_{A}α_{B}+β_{A}β_{B}=0 (1)

S₃₁=(−jα_{A})(−β_{B})+(−β_{A})(−jα_{B})=j(α_{A}β_{B}+β_{A}α_{B})=j (2)

Through algebraic manipulations, it can be obtained that a_{A}=β_{B} and α_{B}=β_{A}. In addition, the characteristic impedances of respective branches can be obtained by the following formulas:

Z₁=\sqrt{Zₒ₁Zᵢ₁} sin Θ (3)

Z₃=\sqrt{Zᵢ₁Zᵢ₂} tan Θ (4)

Z_{α}=\sqrt{Zᵢ₂Zₒ₂} sin Θ (5)

Z₂=\sqrt{Zₒ₁Zₒ₂} tan Θ (6)

Z₆=\sqrt{Zᵢ₁Zₒ₂} cos Θ (7)

Z_{b}=\sqrt{Zₒ₁Zₒ₂} cot Θ (8)

Z₅=\sqrt{Zₒ₁Zᵢ₂} cos Θ (9)

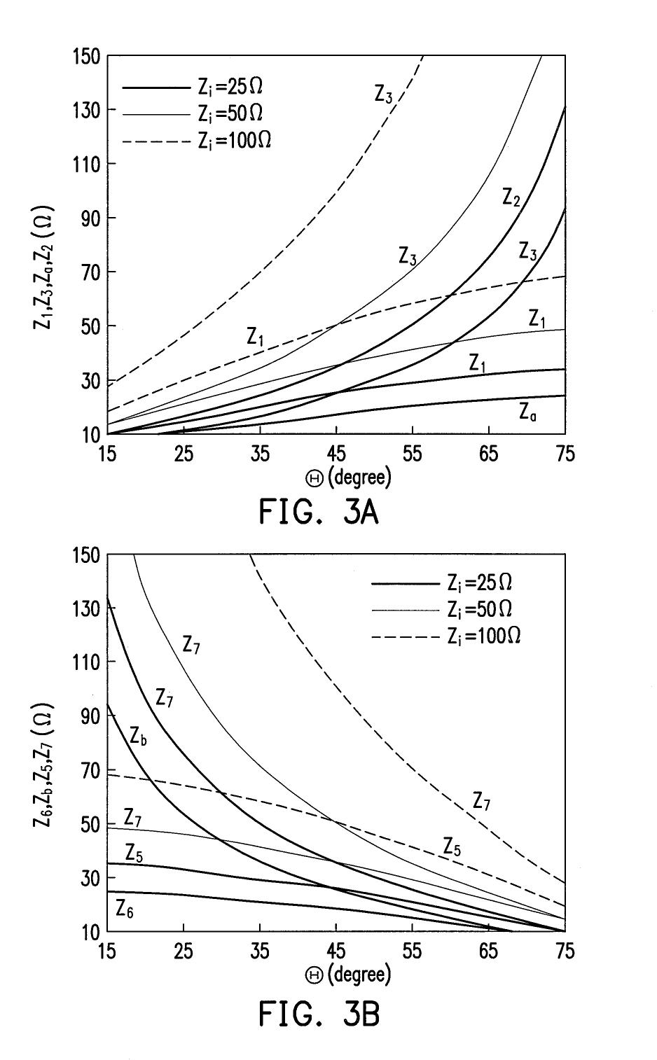

Z₇=\sqrt{Zᵢ₁Zᵢ₂} cot Θ (10)

where sinΘ=α_{A}, cosΘ=β_{A}, and Z₀₁-Z₀₄ are the load impedances of the first to fourth ports P1-P4 that are already known. Therefore, as long as the load impedances Zᵢ₁ and Zᵢ₂ are given, a chart illustrating the relationship between the parameter Θ and the characteristic impedances can be obtained, wherein the parameter Θ is a variable representing the power distribution. For example, FIG. 3A and FIG. 3B are curve charts illustrating the relationship between the parameter Θ and the characteristic impedance of the branch coupler of FIG. 2. In the embodiment illustrated in FIG. 3A and FIG. 3B, the load impedance Zₒ₁=50Ω, the load impedance Zₒ₂=25Ω, and both the load impedance Zᵢ₁ of the second port P2A and the load impedance Zᵢ₂ of the third port P3A are equal to Zⱼ. The embodiment of FIG. 3A and 3B sets three different load impedances Zⱼ, i.e. 25Ω, 50Ω and 100Ω, respectively, each of which corresponds to a different group of characteristic impedances of Z₁, Z₂, Z₃, Z₅, Z₆, Z₇, Zₐ and Z_{b}. In addition, the branch 104 of FIG. 1 can be viewed as the branch 104A and the branch 104B of FIG. 2 that are connected in parallel. Therefore, the characteristic impedance Z₄ of the branch 104 can be expressed as Z₄=Za//Zb. As a result, the characteristic impedance of each branch of FIG. 1 can be obtained by referring to the embodiment of FIG. 2.

For example, in the asymmetric branch coupler 200A, the scattering coefficients S_{21A} and S_{31A} of the asymmetric branch coupler 200A are −jα_{A} and β_{A}, respectively. Therefore, the ratio of power distribution from the first port P1A to the second port P2A and from the first port P1A to the third port P3A is α_{A}²/β_{A}². In addition, since sin Θ=α_{A} and cos Θ=β_{A}, the characteristic impedance of each branch of the asymmetric branch coupler 200A can be obtained as long as the parameter Θ is determined based on the ratio of the power to be distributed to the second port P2A and the third port P3A. For example, assuming both the load impedance Zi1 of the second port P2A and the load impedance Zi2 of the third port P3A of the asymmetric branch coupler 200A are 50Ω, and the power distribution ratio of the power to be distributed to the second port P2A and third P3A are 25% and 75%, respectively, the parameter (phase) Θ can be set as Θ=30°. As such, by referring to the chart of FIG. 3A which illustrating the relationship between the parameter Θ and the characteristic impedance, it can be obtained that the characteristic impedance of the branches 101, 103, 102, 104A are 26Ω ` 28Ω` 20Ω` and 12Ω, respectively.

It is noted that the Zⱼ values exemplified in the present embodiment are for the purposes of illustration only and should not be regarded as limiting, and the load impedances Zᵢ₁, Zᵢ₂ can also be other values. That is, the user may set the impedances Zᵢ₁ and Zᵢ₂, respectively, depending upon actual requirements. In addition, while the first port P1 of the planar asymmetric crossover coupler 100 is illustrated as the input port in the illustrated embodiment, this should not be regarded as limiting. Rather, any port of the planar asymmetric crossover coupler 100 can be used as the input port for the input signal S1. For example, the fourth port P4 may be used as the input port of the planar asymmetric crossover coupler 100. In some embodiments, the planar asymmetric crossover coupler can have two input ports at the same time. For example, both the first port P1 and the fourth port P4 of the planar asymmetric crossover coupler 100 can be used as the input ports to receive different signals to be transmitted to the third port P3 and the second port P2, respectively. In embodiments having different input port configurations, the characteristic impedance of each branch of the asymmetric branch coupler 200A can be calculated in a similar manner as described in the embodiment of FIG. 2 and, therefore, explanation thereof is not described herein.

Similarly, the characteristic impedances of the branches 105, 106, 107 and 104B of the asymmetric branch coupler 200B can also be obtained according to the power distribution ratio of the power to be distributed to the second and third ports P2B, P3B and the load impedances of respective ports of the asymmetric branch coupler 200B. Calculation of the characteristic impedance of each branch of the asymmetric branch coupler 200B can be the same as that of each branch of the asymmetric branch coupler 200A and, therefore, explanation thereof is not described herein. As such, by setting the power distribution ratio of respective output ports of the asymmetric branch coupler 200A and the asymmetric branch coupler 200B of FIG. 2, the power distribution ratio of each output port of the planar asymmetric crossover coupler 100 of FIG. 1 can be freely adjusted.

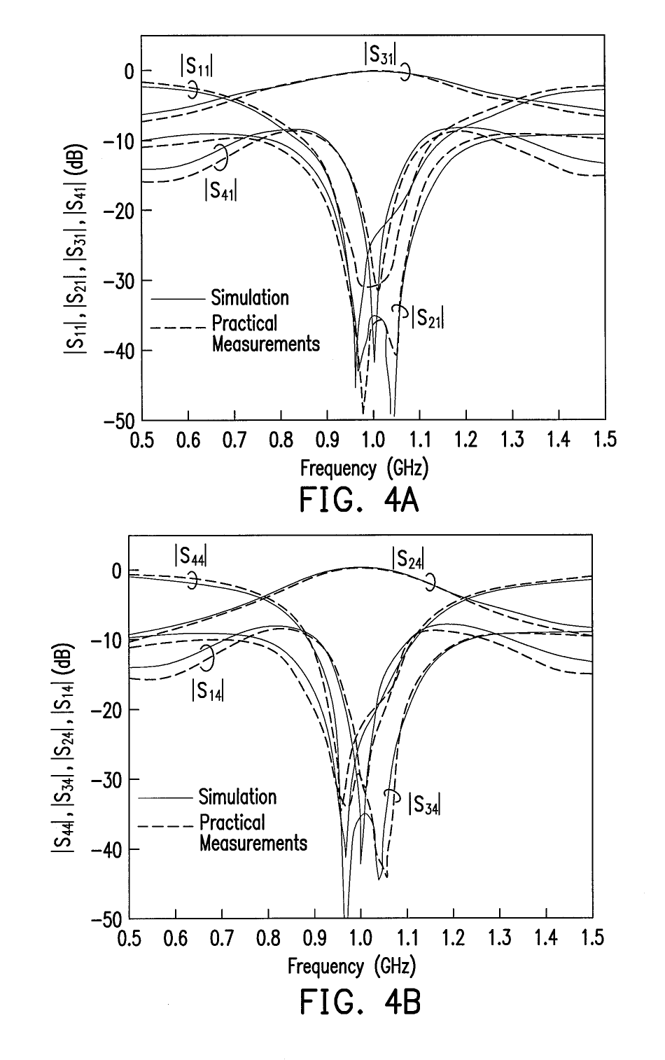

FIG. 4A is a chart illustrating the frequency response of the planar asymmetric crossover coupler 100 according to one embodiment of the present invention. Referring to FIG. 4A, in the present embodiment, the load impedance Z₀₁ is set as 50Ω, Z₀₂ is set as 75Ω, and the center frequency of the planar asymmetric crossover coupler 100 is set as 1 GHz. The input signal S1 is inputted from the first port P1 of the planar asymmetric crossover coupler 100. From FIG. 4A which illustrates both the simulation and practical measurements, it can be seen that the scattering coefficients S₁₁, S₂₁, S₃₁, S₄₁ of the planar asymmetric crossover coupler 100 at 1 GHz are −30.07 dB ` −35.8 dB ` −0.25 dB and −29.4 dB, respectively. The power consumption (1-|S₁₁|²-|S₂₁|²-|S₃₁|²-|S₄₁|²) is about 5.4%. The 20-dB bandwidths of |S₁₁, |S₂₁| and |S₄₁| are 14%, 19.5% and 7%, respectively. In addition, the 0.5-dB bandwidth of |S₃₁ is about 18%. As can be seen, the planar asymmetric crossover coupler 100 can indeed cause the first port P1 and the second port P2 to be isolated from each other, cause the first port P1 and the fourth port P4 to be isolated from each other, and thereby power of the input signal S4 can completely pass through the crossover junction, to the third port P3.

Similarly, the input signal S1 can also be inputted from the fourth port P4 of the planar asymmetric crossover coupler 100. FIG. 4B is a chart illustrating the frequency response of the planar asymmetric crossover coupler 100 according to another embodiment of the present invention. Referring to FIG. 4B, in the present embodiment, the load impedance Z₀₁ is set as 50Ω, Z₀₂ is set as 75Ω. From FIG. 4B which illustrates both the simulation and practical measurements, it can be seen that the scattering coefficients S₁₄, S₂₄, S₃₄, S₄₄ of the planar asymmetric crossover coupler 100 at 1 GHz are −29.3 dB ` −0.28 dB ` −30.2 dB and −22.6 dB, respectively. The power consumption (1-|S₁₄|²-|S₂₄|²-|S₃₄|²-|S₄₄|²) is about 5.5%. The 20-dB bandwidths of |S₁₄|, |S₃₄| and |S₄₄| are 7%, 20.5% and 11.5%, respectively. In addition, the 0.5-dB bandwidth of |S₂₄| is about 17%. As can be seen, in the case of the fourth port P4 of the planar asymmetric crossover coupler 100 as the input port, the planar asymmetric crossover coupler 100 can also effectively cause the first port P1 and the fourth port P4 to be isolated from each other, cause the third port P3 and the fourth port P4 to be isolated from each other, and thereby the power of the input signal S4 can completely pass through to the second port P2.

In summary, the embodiments of present invention can adjust the load impedance and output power of the planar asymmetric crossover coupler to meet the requirements of microwave circuits by adjusting the characteristic impedance of respective branches of the planar asymmetric crossover coupler. As such, the crossover coupler can have high design flexibility. The simplified architecture of the crossover coupler not only makes the crossover coupler suitable for use in single or multiple layer planar circuits, but also reduces the fabrication cost thereof.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A planar asymmetric crossover coupler comprising:
a first branch to a seventh branch, wherein the first branch to the fourth branch form a first region having a first port and a fourth port, the fourth branch to the seventh branch form a second region having a second port and a third port, and the characteristic impedance of each branch is determined according to the load impedance and power distribution ratio of each port.

2. The planar asymmetric crossover coupler according to claim 1, wherein the length of each branch is one quarter wavelength at the center frequency of the planar asymmetric crossover coupler.

3. The planar asymmetric crossover coupler according to claim 1, wherein the length of each branch is one over four of the wavelength at the center frequency of the planar asymmetric crossover coupler.

4. The planar asymmetric crossover coupler according to claim 1, wherein the first port is positioned at the junction of the first branch and the third branch, the second port is positioned at the junction of the fifth branch and the sixth branch, the third port is positioned at the junction of the fifth branch and the seventh branch, and the fourth port is positioned at the junction of the second branch and the third branch.

5. The planar asymmetric crossover coupler according to claim 4, wherein the load impedance of the first port is equal to the load impedance of the third port, and the load impedance of the second port is equal to the load impedance of the fourth port.

6. The planar asymmetric crossover coupler according to claim 4, wherein if the first port is an input port, then the fourth port is an isolation port, and the second and third ports are output ports.
